(19) United States
(12) Patent Application Publication
(10) Pub. No.: US 2025/0033028 A1
(43) Pub. Date: Jan. 30, 2025

(54) HYBRID-BONDED CHROMATOGRAPHY MATERIALS

(71) Applicant: Waters Technologies Corporation, Milford, MA (US)

(72) Inventors: MingCheng Xu, Lexington, MA (US); Matthew Lauber, North Smithfield, RI (US); Balasubrahmanyam Addepalli, Hopkinton, MA (US); Kristine Joy Camacho, Franklin, MA (US); Oksana Tchoul, Winchester, MA (US); Lavelay Kizekai, Coventry, RI (US)

(73) Assignee: Waters Technologies Corporation, Milford, MA (US)

(21) Appl. No.: 18/785,487

(22) Filed: Jul. 26, 2024

Related U.S. Application Data
(60) Provisional application No. 63/516,197, filed on Jul. 28, 2023.

(51) Int. Cl. B01J 20/289; B01J 20/22; B01J 20/28; G01N 30/16; G01N 30/74

(52) U.S. Cl. CPC B01J 20/289; B01J 20/22; B01J 20/28052; B01J 20/28083; B01J 20/28085; G01N 30/16; G01N 30/74; B01J 2220/54

(57) ABSTRACT

The present disclosure is directed to hybrid-bonded siliceous materials. The materials of the present disclosure exhibit enhanced base stability and reduced baseline noise. As such, the materials disclosed herein are suitable for use across a range of chromatography applications, including size-exclusion chromatography and reversed-phase chromatography.

### CROSS-REFERENCE TO RELATED APPLICATIONS

This application claims the benefit of U.S. Provisional Application No. 63/516,197 filed on Jul. 28, 2023, the entirety of which is incorporated herein by reference.

### FIELD OF INVENTION

The present technology is directed to chromatography materials with siliceous surfaces. More particularly, the present technology is directed to chromatography materials with a bonding phase consisting of two or more silane compounds.

### BACKGROUND

Liquid chromatography is an analytical technique pervasive throughout the pharmaceutical, biotechnology, and chemical industries. Liquid chromatography involves two phases: a stationary phase and a mobile phase. Typically, the stationary phase comprises particles that are packed into a column and the mobile phase flows a sample across the stationary phase. Particulate silica is the most widely used stationary phase material due to its mechanical strength, tailorable pore structure, and diversity of surface chemistries.

However, silica particles are subject to degradation over time due to lack of stability of the base particle and the susceptibility of Si—O—Si linkages to hydrolysis when exposed to high pH levels. These limitations have significant impacts on the utility of silica-based particles in liquid chromatography applications.

One key application of liquid chromatography is size exclusion chromatography (SEC), which is frequently used in the analysis of size heterogeneity of large biological analytes, such as adeno-associated viruses (AAV), mRNA, plasmid, and lipid nanoparticles. This analysis relies on the separation of analytes within a sample by size, coupled with measurements using multi-angle light scattering. However, due to the aforementioned limitations, these materials are known to shed nanosized particulate silicates, which can directly and/or indirectly interfere with light scattering, thus confounding analytical results.

Accordingly, there exists a need in the art for silica-based chromatographic materials with broad functionality and improved stability at high pH levels.

### SUMMARY OF INVENTION

In general, the present technology is directed to a hybrid-bonded materials for use in liquid chromatography applications. Accordingly, in one aspect disclosed herein is a chromatographic material comprising a particle with a siliceous surface, wherein the siliceous surface consists of a bonding phase formed by at least two silane compounds, wherein one of the at least two silane compounds is a dipodal hybrid silane comprising two indirectly linked silica atoms, and one of the at least two silane compounds is a functionalized silane. In some embodiments, the particle is a polymer particle, a silica particle, or an inorganic-organic hybrid particle.

In some embodiments, the dipodal hybrid silane is selected from the group consisting of:

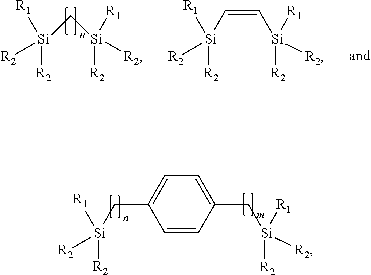

wherein R₁ is each independently chlorine, methoxyl, or ethoxyl; R₂ is each independently alkyl, methoxyl, or chlorine; and n and m are each independently 1-4.

In some embodiments, the functionalized silane is selected from the group consisting of:

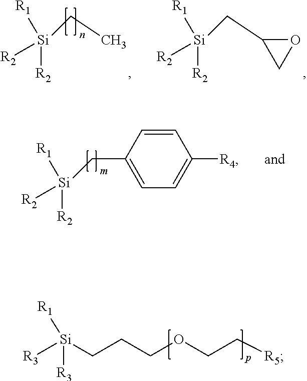

wherein R₁ is each independently chlorine, methoxyl, or ethoxyl; R₂ is each independently alkyl, benzyl, methoxyl, or chlorine; R₃ is each independently alkyl, methoxyl, ethoxyl, or chlorine; R₄ is H or benzene; R₅ is hydroxyl or methoxyl; n is 3, 7, or 17; m is 0 or 1; and p is an integer from 1-12.

In some embodiments of the instant technology, the dipodal hybrid silane and the functionalized silane are charged at a molar ratio of about 1:1, about 1:2, about 1:4, or about 1:10. In some embodiments, the dipodal hybrid silane and the functionalized silane are charged at a molar ratio of about 1:2 or about 1:4. In some embodiments, the functionalized silane has a surface coverage of 60% to 250% of a theoretical maximum surface coverage (μmol/m²) of the functionalized silane.

In one aspect, the functionalized silane is

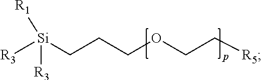

wherein R₁ and R₃ are ethoxyl; R₅ is hydroxyl; and p is 8-12. In some embodiments, the surface coverage of the functionalized silane is between about 0.8 to about 3.45 μmol/m².

In some embodiments, the chromatographic material has a pore size of between about 90 Å to 5000 Å. In some embodiments, the chromatographic material has a pore size of about 100 to 400 Å. In some embodiments, the chromatographic material has a pore size of about 400 to 5000 Å. In some embodiments, the chromatographic material has a pore size of between about 600 to 2000 Å. In some embodiments, the chromatographic material has a pore size of between about 1000 to 2500 Å.

In some embodiments, the dipodal hybrid silane and the functional silane of the chromatographic material are present at a molar ratio of between 0.1:1 to 3:1 (dipodal hybrid silane:functional silane). In some embodiments, the dipodal hybrid silane and the functional silane are present at a molar ratio of about 0.1:1. In some embodiments, the dipodal hybrid silane and the functional silane are present at a molar ratio of about 0.4:1. In some embodiments, the dipodal hybrid silane and the functional silane are present at a molar ratio of about 1:1. In some embodiments, the dipodal hybrid silane and the functional silane are present at a molar ratio of about 1.3:1.

In some embodiments, the chromatographic material is resistant to hydrolytic corrosion as detected by a minimum change of separation performance before and after exposure to the hydrolytic condition. In some embodiments, the chromatographic material has low baseline noise as measured by a multi-angle light scattering (MALS) detector.

In one aspect, the technology comprises a chromatographic column comprising the chromatographic materials disclosed herein. In one aspect, the technology comprises a chromatographic device comprising a chromatographic column comprising the chromatographic materials disclosed herein, a column injector positioned upstream of the chromatographic column, and tubing in fluidic connection with and located downstream of the chromatographic column. In some embodiments, the chromatographic device further comprises a detector in fluidic connection with and located downstream of the chromatographic column. In some embodiments, the detector is a multi-angle light scattering (MALS) detector or an ultraviolet detector. In some embodiments, the chromatographic device is suitable for use in size exclusion chromatography or reversed-phase chromatography. In some embodiments, the chromatographic material is resistant to hydrolytic corrosion as detected by MALS noise and/or by separation of a protein and/or nucleoside sample. In some embodiments, the MALS noise is measured as peak-to-peak noise in μV, and wherein the peak-to-peak noise is ≤800 μV.

### BRIEF DESCRIPTION OF THE DRAWINGS

The technology will be more fully understood from the following detailed description taken in conjunction with the accompanying drawings.

FIG. 1 is an illustration of a particle with a bonding phase formed by a dipodal hybrid silane and a functionalized silane in accordance with an embodiment of the technology.

FIGS. 2A-D graphically depict four particles which differ by the functionalized silane utilized in the bonding phase. FIG. 2A contains a PEG-functionalized silane. FIG. 2B contains a diol-functionalized silane. FIG. 2C contains a phenyl- or biphenyl-functionalized silane. FIG. 2D contains a C4, C8, or C18-functionalized silane.

FIGS. 3A-C demonstrates the improved base stability and separation afforded by the particles of the present technology by comparing separation performance before and after exposure to basic conditions. FIG. 3A shows the separation of thyroglobulin, IgG, BSA, myoglobin, and uracil using materials with only PEG-functionalized silane. FIG. 3B and FIG. 3C show the separation of thyroglobulin, IgG, BSA, myoglobin, and uracil using hybrid-bonded materials of the present technology that differ by surface coverage.

FIG. 4 demonstrates the reduced light scattering noise as detected by multi-angle light scattering (MALS) afforded by the particles of the present technology.

FIGS. 5A-B show the separation of DNA fragments using hybrid-bonded particles of the present technology (FIG. 5A) as compared to a commercial column (FIG. 5B).

FIGS. 6A-B show the separation of AAV capsids using hybrid-bonded particles of the present technology (FIG. 6A) as compared to a commercial column (FIG. 6B).

FIG. 7 shows the separation of double-stranded DNA and single-stranded DNA using hybrid-bonded particles of the present technology.

FIGS. 8A-8B show the separation of two lipid nanoparticle samples (LNP Sample #1, FIG. 8A and LNP Sample #2, FIG. 8B) using hybrid-bonded particles of the present technology.

FIGS. 9A-9C provide exemplary proton NMR (¹H NMR) of alkaline-digested particles of the present technology. FIG. 9A provides spectra for particles having BTEE/PEG-bonded silica. FIG. 9B provides spectra for particles having only PEG-bonded silica. FIG. 9C provides potential hydrolysis products.

### DETAILED DESCRIPTION

In order that the technology may be more readily understood, certain terms are first defined. In addition, it should be noted that whenever a value or range of values of a parameter are recited, it is intended that values and ranges intermediate to the recited values are also part of this disclosure. The word “about” if not otherwise defined means±5%. It is also to be noted that as used herein and in the claims, the singular forms “a” and “the” include plural references unless the context clearly indicates otherwise.

### Definitions

As used herein, the term “dipodal hybrid silane” refers to a silane molecule comprising two indirectly linked silicon atoms via Si—C and C—C bonds.

As used herein, the term “functionalized silane” refers to a silane molecule that contains a functional group. The functional group imparts one or more chromatographic functionalities. For example, the functionalized silane may contain a polyethylene glycol (PEG) group.

As used herein, the term “bonding phase” refers to the composition bonded to the surface of the particle. In a preferred embodiment, the bonding phase consists of a binary composition of silanes that confer a dipodal hybrid region and a functional region. The term “dipodal hybrid region” refers to the portion of the bonding phase that includes the dipodal hybrid silane. The term “functional region” refers to the portion of the bonding phase that includes the functionalized silane.

As used herein, the term “hybrid-bonded” refers to a bonding phase that includes a dipodal hybrid region containing Si—C and C—C bonds.

As used herein, the term “surface coverage” refers to the density of a bonding phase present on a particle surface. In the context of the present technology, surface coverage can refer to the density of the functional region (i.e., the functionalized silane) in the bonding phase. Surface coverage can be calculated using the weight loss in thermogravimetric analysis (TGA) and carbon percentage of the particle as measured by elemental analysis. Unless indicated otherwise, surface coverage is measured in μmol of silane compound per m² of particle surface area.

As used herein, the term “hydrolytic corrosion” refers to the hydrolysis of covalent bonds when exposed to certain conditions. This could include, for example, the hydrolysis of Si—O—Si bonds when exposed to basic conditions. Hydrolytic corrosion in the context of silica-based particles can result in the shedding of silicates. These silicates can interfere with downstream analyses which rely on light scattering measurements.

The term “nonporous particle” refers to a particle that has a pore volume that is less than 0.05 cc/g. The term “porous particle” refers to a particle that has a pore volume that is greater than 0.05 cc/g, and more preferably between 0.1 cc/g and 1.5 cc/g or 2 cc/g. Pore volume and size are determined using methods known in the art, including nitrogen Brauner-Emmett-Teller (BET) theory or mercury intrusion porosimetry.

Unless defined otherwise, all technical and scientific terms used herein have the same meaning as commonly understood by one of ordinary skill in the art to which this disclosure belongs.

### Materials

The present technology is directed to hybrid-bonded materials that exhibit increased stability when exposed to hydrolytic conditions such as high pH. Due to the improved stability, the hybrid-bonded materials of the present disclosure result in reduced baseline noise when used in chromatography applications. The improved stability and reduced baseline noise of the hybrid-bonded materials of the instant technology further permit their use in a broader range of chromatography applications as compared to materials known in the art.

The materials of the present technology have a bonding phase that comprises at least two distinct silane compounds: a dipodal hybrid silane and a functionalized silane. The dipodal hybrid silane contains at least two indirectly linked silicon atoms via Si—C and C—C bonds, resulting in a dipodal hybrid region. This dipodal hybrid region comprises intrinsic base stable Si—C and C—C bonds, and also provides a hydrophobic microenvironment that shields the underlying Si—O—Si bonds of the particle surface. The functionalized silane affords the functional region of the bonding phase and is connected by the dipodal hybrid region. The functional region confers one or more advantageous chromatographic properties to the particle, permitting its use in a range of chromatographic applications.

In one aspect of the present technology, the dipodal hybrid silanes are selected from the group consisting of:

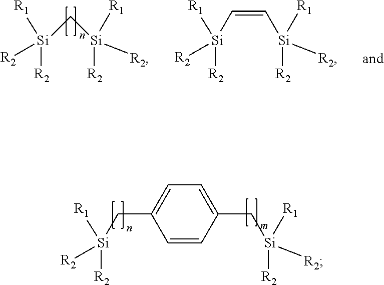

wherein
R₁ is each independently chlorine, methoxyl, or ethoxyl;
R₂ is each independently alkyl, methoxyl, ethoxyl, or chlorine; and
n and m are each independently 1-4.

In one aspect of the present technology, the functionalized silanes are selected from the group consisting of:

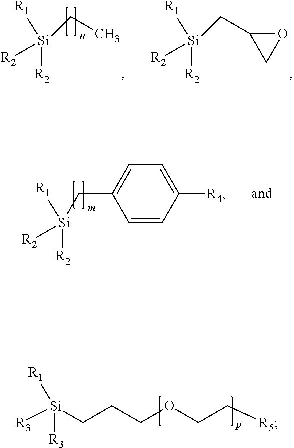

R₁ is each independently chlorine, methoxyl, or ethoxyl;
R₂ is each independently alkyl, benzyl, methoxyl, ethoxyl, or chlorine;
R₃ is each independently alkyl, methoxyl, ethoxyl, or chlorine;
R₄ is H or benzene;
R₅ is hydroxyl or methoxyl;
n is 3, 7, or 17;
m is 0 or 1; and
p is an integer from 1-12.

As one of ordinary skill in the art would readily understand, the functional group of the functionalized silane will determine the chromatographic properties of the resultant material. In some embodiments the functionalized silane may confer properties advantageous for size-exclusion chromatography. In other embodiments, the functionalized silane may confer properties advantageous for reversed-phase chromatography or ion-exchange chromatography. In some embodiments, two or more distinct functionalized silanes are utilized.

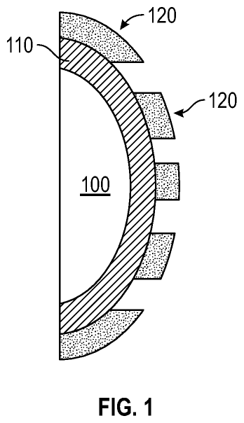

FIG. 1 illustrates an exemplary particle of the present technology. The bonding phase 110 is applied to the underlying particle 100. Bonding phase 110 includes at least one dipodal hybrid silane and at least one functionalized silane. The functional groups 120, provided by the functionalized silane, confer chromatographic properties to the particle. The bonding phase 110 can be applied to a range of particle types.

The particles can range in size from 1 to 100 μm and can be porous, superficially porous, or non-porous. The term “superficially porous” refers to a particle comprising a solid core surrounded by a porous shell.

While it is necessary that the particles have a siliceous surface, this siliceous surface may be intrinsic or acquired. In the case of the former, the particle may be a porous or nonporous silica particle or an inorganic-organic hybrid particle. Alternatively, particles with acquired siliceous surfaces include a polymer particle that is surface coated with a layer of silica or a hybrid inorganic-organic layer.

Accordingly, in some aspects, the particle 100 may be a porous silica particle, a nonporous silica particle, a porous inorganic-organic hybrid particle, a nonporous inorganic-organic hybrid particle, or a polymer particle.

In some embodiments, the porous particle may have an average pore size of between 90 Å to 5000 Å. In some embodiments, the porous particle may have an average pore size of between 90 to 400 Å. In some embodiments, the porous particle may have an average pore size of between 400 to 5000 Å. In some embodiments, the porous particle may have an average pore size of between 600 to 2000 Å. In some embodiments, the porous particle may have an average pore size of between 1000 to 2500 Å.

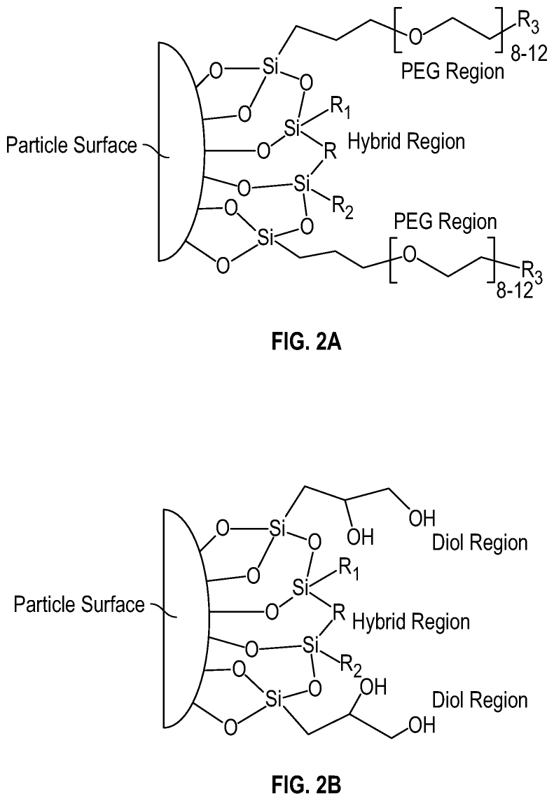

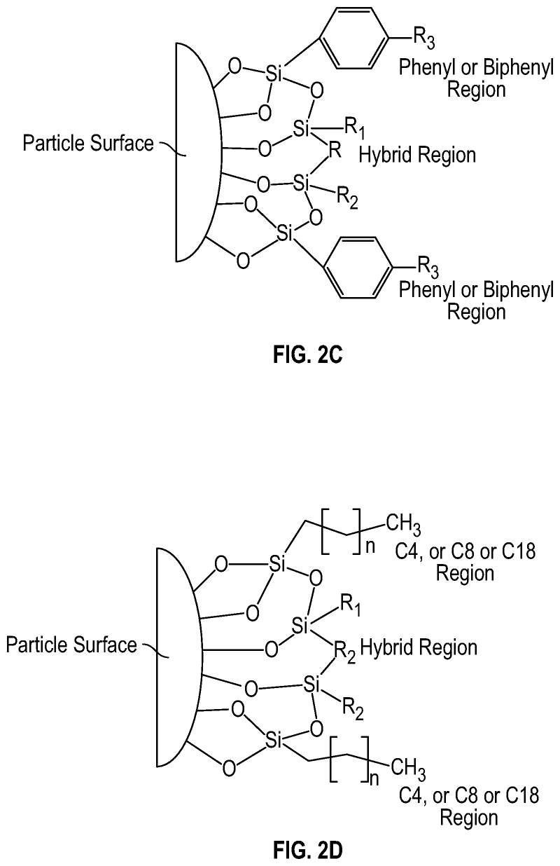

FIG. 2A-D provide exemplary particles of the present technology. FIG. 2A shows a particle wherein the functionalized silane contains a polyethylene glycol (PEG) group. FIG. 2B shows a particle wherein the functionalized silane contains a diol group. FIG. 2C shows a particle wherein the functionalized silane contains a phenyl or biphenyl group. FIG. 2D shows a particle wherein the functionalized silane contains a C4, C8, or C18 group. For each particle, the hybrid region of the bonding phase provides a hydrophobic microenvironment that protects the underlying Si—O—Si bonds of the particle surface. Further, the functional regions allow for the use of the materials in different chromatographic applications. For instance, the materials of FIG. 2A-B are suitable for use in size-exclusion chromatography, whereas the materials of FIG. 2C-D are suitable for use in reverse-phase chromatography.

Due to the binary composition of the bonding phase, the charged molar ratio of hybrid to functional region is important to the performance of the material. In one aspect, disclosed herein are particles wherein the charged molar ratio of hybrid to functional region is between 1:1.4 to 1.3. More preferably, the ratio is 1:2 to 1:1.6. As the hybrid to functional region ratio is directly dependent on the density of the respective silane compounds, it is necessary to determine the surface coverage of the silane compounds in the bonding phase.

The result hybrid-bonded particle has a molar ratio of dipodal hybrid silane to functionalized silane. In some embodiments, the molar ratio of dipodal hybrid silane to functionalized silane is about 0.1:3 (dipodal hybrid silane:functionalized silane). In some embodiments, the molar ratio of dipodal hybrid silane to functionalized silane is about 0.1:1 about 0.2:1, about 0.4:1, about 0.5:1, about 0.8:1, about 1:1, about 1.3:1, about 1.5:1, about 2:1 about 2.3:1 about 2.5:1 about 3:1, or any range in between said values. In some embodiments, the molar ratio of dipodal hybrid silane to functionalized silane is about any value between 0.4:1 to 1.3:1. In some embodiments, the molar ratio of dipodal hybrid silane to functionalized silane is about any value between 0.4:1 to 3:1. Without wishing to be bound by any particular theory, altering the ratio of dipodal hybrid silane to functionalized silane can alter the hydrophobicity of the surface of the particle, which can confer advantages for particular chromatography applications. For example, but not by way of limitation, a hybrid-bonded particle having a molar ratio in the range from 0.4:1 to 1.3:1 may be suitable for use with size-exclusion chromatography, and a hybrid-bonded particle having a molar ratio between the range from 0.4:1 to 3:1 may be suitable for use with reverse phase chromatography.

In one aspect, the hybrid-bonded particles of the present technology comprise:
(i) a dipodal hybrid silane of the formula

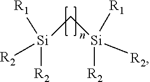

wherein
R₁ is each independently chlorine, methoxyl, or ethoxyl;
R₂ is each independently alkyl, methoxyl, ethoxyl, or chlorine; and
n is 1-4; and
(ii) a functionalized silane of the formula

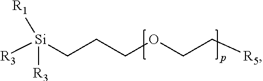

wherein R₁ is each independently chlorine, methoxyl, or ethoxyl;
R₃ is each independently alkyl, methoxyl, ethoxyl, or chlorine;
R₅ is hydroxyl or methoxyl; and
p is an integer from 1-12.

In some embodiments, said hybrid-bonded particles have an average pore size of about 400 to 5000 Å. In some embodiments, the average pore size is about 600 Å to 2500 Å. In some embodiments, the dipodal hybrid silane and the functional silane are present at any value between the range of a molar ratio of about 0.1:1 to 3:1 (dipodal hybrid silane to functional silane). In some embodiments, the dipodal hybrid silane and the functional silane are present at a molar ratio value between of 0.4:1 to 1.3:1.

In one aspect, the hybrid-bonded particles of the present technology comprise:
(i) a dipodal hybrid silane of the formula

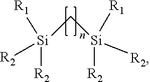

wherein
R₁ is each independently ethoxyl;
R₂ is each independently ethoxyl; and
n is 2; and
(ii) a functionalized silane of the formula

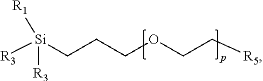

wherein R₁ is each independently ethoxyl;
R₃ is each independently ethoxyl;
R₅ is hydroxyl; and
p is an integer from 8-12.

In some embodiments, said hybrid-bonded particles have an average pore size of about 400 to 5000 Å. In some embodiments, the average pore size is about 600 Å to 2500 Å. In some embodiments, the dipodal hybrid silane and the functional silane are present at any value between the range of molar ratio of about 0.1:1 to 3:1 (dipodal hybrid silane to functional silane). In some embodiments, the dipodal hybrid silane and the functional silane are present at any value between a range of a molar ratio from 0.4:1 to 1.3:1.

In one aspect, the hybrid-bonded particles of the present technology comprise:
(i) a dipodal hybrid silane of the formula

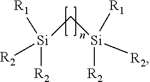

wherein
R₁ is each independently chlorine, methoxyl, or ethoxyl;
R₂ is each independently alkyl, methoxyl, ethoxyl, or chlorine; and
n is 1-4; and
(ii) a functionalized silane of the formula

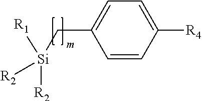

wherein
R₁ is each independently chlorine, methoxyl, or ethoxyl;
R₃ is each independently alkyl, methoxyl, ethoxyl, or chlorine;
R₄ is H or benzene; and
m is 0 or 1.

In some embodiments, n is 2 and R₄ is benzene. In some embodiments, said hybrid-bonded particles have an average pore size of about 90 to 400 Å. In some embodiments, the dipodal hybrid silane and the functional silane are present at any value between a range of molar ratio of about 0.1:1 to 3:1 (dipodal hybrid silane to functional silane). In some embodiments, the dipodal hybrid silane and the functional silane are present at a value between molar ratio of 0.4:1 to 3:1.

In one aspect, the hybrid-bonded particles of the present technology comprise:
(i) a dipodal hybrid silane of the formula

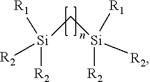

wherein
R₁ is each independently chlorine, methoxyl, or ethoxyl;
R₂ is each independently alkyl, methoxyl, ethoxyl, or chlorine; and
n is 1-4; and
(ii) a functionalized silane of the formula

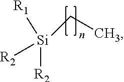

wherein
R₁ is each independently chlorine, methoxyl, or ethoxyl;
R₂ is each independently alkyl, benzyl, methoxyl, ethoxyl, or chlorine;
R₃ is each independently alkyl, methoxyl, ethoxyl, or chlorine; and
n is 3, 7, or 17.

In some embodiments, the first instance of n in the dipodal hybrid silane is 2 and the second instance of n in the functionalized silane is 3. In some embodiments, the first instance of n in the dipodal hybrid silane is 2 and the second instance of n in the functionalized silane is 7. In some embodiments, the first instance of n in the dipodal hybrid silane is 2 and the second instance of n in the functionalized silane is 17. In some embodiments, said hybrid-bonded particles have an average pore size of about 90 to 400 Å. In some embodiments, the dipodal hybrid silane and the functional silane are present at any value between a range of molar ratio of about 0.1:1 to 3:1 (dipodal hybrid silane to functional silane). In some embodiments, the dipodal hybrid silane and the functional silane are present at value between a molar ratio range from 0.4:1 to 3:1.

In one aspect, the hybrid-bonded particles of the present technology comprise:
(i) a dipodal hybrid silane of the formula

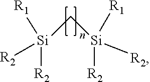

wherein
R₁ is each independently chlorine, methoxyl, or ethoxyl;
R₂ is each independently alkyl, methoxyl, ethoxyl, or chlorine; and
n is 1-4; and
(ii) a dipodal hybrid silane selected from the group consisting of:

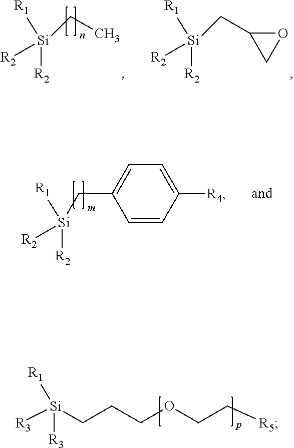

wherein R₁ is each independently chlorine, methoxyl, or ethoxyl;
R₂ is each independently alkyl, benzyl, methoxyl, ethoxyl, or chlorine;
R₃ is each independently alkyl, methoxyl, ethoxyl, or chlorine;
R₄ is H or benzene;
R₅ is hydroxyl or methoxyl;
n is 3, 7, or 17;
m is 0 or 1; and
p is an integer from 1-12.

In some embodiments, the first instance of n in the dipodal hybrid silane is 2. In some embodiments, said hybrid-bonded particles have an average pore size of about 90 to 400 Å. In some embodiments, the dipodal hybrid silane and the functional silane are present at a value between molar ratio range of about 0.1:1 to 3:1 (dipodal hybrid silane to functional silane). In some embodiments, the dipodal hybrid silane and the functional silane are present at a value between a molar ratio range from 0.4:1 to 3:1.

### Material Characterization

Surface coverage of the silane compounds in the bonding phase has direct implications on the improved properties of the materials disclosed herein. Accordingly, it is important to first determine the theoretical maximum surface coverage of the silane compound. Theoretical maximum surface coverage can be estimated using the hydrodynamic or Stokes radius of the silane compound. The hydrodynamic or Stokes radius can be determined using methods known in the art.

Using the hydrodynamic or Stokes radius of the silane, the surface area needed for each molecule is first calculated/estimated using the equation:

$$A = π {r}^{2}$$

Once the surface area needed for each molecule is known, the minimum surface area for 1 μmol can be determined using Avogadro's Constant (6.022×10²³). The inverse of this value provides the maximum coverage of 1 μmol per m².

In some embodiments of the present technology, the surface coverage of the functional region is between 60% to 250% of the theoretical maximum coverage. In preferred embodiments, the surface coverage of the functional region is between 80% to 130%.

As an example of monolayer bonding, the theoretical maximum surface coverage of a functionalized PEG (8-12 repeat unit) silane, with a hydrodynamic radius of 0.61 nm, is approximately 1.38 μmol/m². As such, the desired surface coverage of the functionalized silane can range between 0.8 μmol/m² and 3.45 μmol/m².

Once the bonding phase is applied to the particle, the actual surface coverage can be quantified by using the carbon percentage in the product and the organic moiety loss as determined by thermogravimetric analysis (TGA). TGA quantifies total percentage of organic by mass loss at a programmed temperature range from 180 to 600° C. As an example, the surface coverage of a bonded silica particle can be calculated using the following equation:

$$Functional Silane Coverage ( μ moles / {m}^{2} ) = \frac{( C - W * C 2 ) ) * 1 {0}^{6}}{( C 1 - C 2 ) ) * M * S A}$$

In the above calculation, C1 and M1 are the respective carbon percentage and molar mass of the combustible organic moiety of the bonded functional silane. C2 is the carbon percentage of the combustible organic moiety of the bonded dipodal silane. SA is the BET surface area of the particle before bonding. W is the weight loss percentage as measured by TGA (200-600° C.), and C is the carbon percentage found in the bonded particle.

As an illustrative example, for a PEG functional silane (with 8-12 repeat unit, on average 10.5 repeat units), C1 is equal to −55.3% and M is equal to −521, and for a BTEE dipodal hybrid silane C2 is equal to −85.71%:

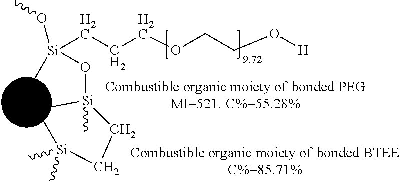

If the underlying particle comprises both carbon and a combustible moiety, the carbon percentage and combustibles of the base particle need to be subtracted from the calculation.

In preferred embodiments, the bonding phase does not significantly alter the pore size of the underlying particle. The pore size of the particles can be measured using methods known in the art, including mercury intrusion porosimetry.

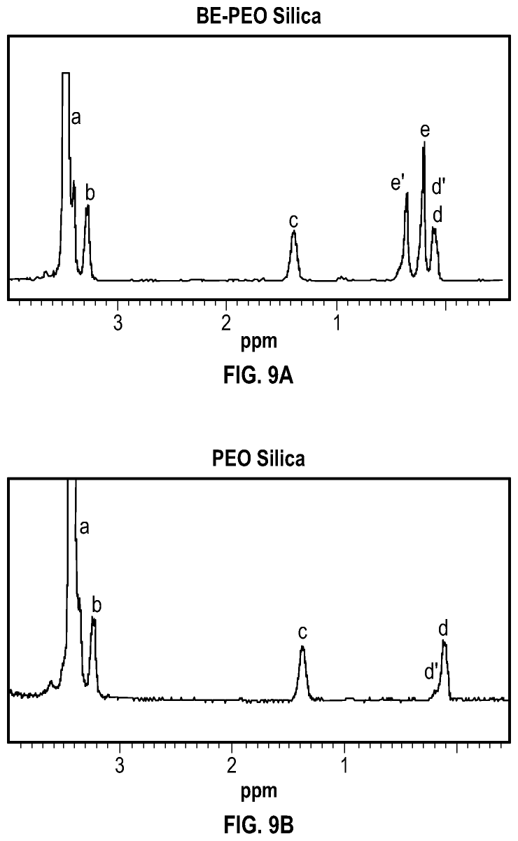

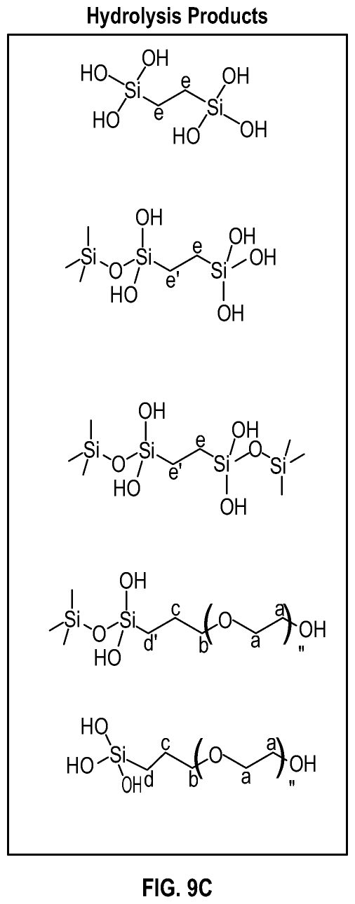

The molar ratio of a dipodal hybrid silane and a functionalized silane of the present technology may be determined using ¹H NMR analysis of digested particle. For example, the molar ratio of bridged ethylene relative to polyethylene oxide (BTEE/OH-PEG) bonded on silica can further be determined using ¹H NMR analysis of digested particles. Particles may be digested using methods known in the art, including for example with 3 mL of 2.5M NaOH solution containing 100:1 (v/v) D₂O/H₂O at 64° C. for 1 hour. FIG. 9A-9C provides exemplary ¹H NMR spectra obtained after alkaline digestion for PEG-only bonded silica (FIG. 9B), BTEE/PEG bonded silica (FIG. 9A), and structures of possible hydrolysis products (FIG. 9C). Chemical shifts at 3.55 ppm, 3.25 ppm, 1.35 ppm, and 0.12 ppm are associated with various methylene protons in hydrolyzed PEG ligands. The Si-CH₂ protons of the ethylene bridges after alkaline digestion show chemical shifts at 0.34 ppm and 0.23 ppm in the ¹H NMR spectrum.

The ratio of BTEE to PEG can be calculated based on the ratio of BTEE Si-CH₂ proton integration at chemical shifts 0.34 ppm (I1) and 0.23 ppm (I2) to PEG proton integration at chemical shift at 1.35 ppm (I3) as shown:

$$\frac{B T E E}{P E G} ( molar ratio ) = \frac{( I 1 + I 2 ) / 4}{I 3 / 2}$$

OH-PEG surface coverage can be calculated based on the % carbon, BTEE/PEG molar ratio, and the particle specific surface area (SA).

### Use of Materials

The materials of the disclosed technology are suitable for use in a range of chromatographic applications. In some embodiments, the materials can be used in size-exclusion chromatography. In some embodiments, the materials can be used in reversed-phase chromatography. In other embodiments, the materials can be used in ion-exchange chromatography.

The materials disclosed herein can be packed into a chromatographic device, such as, for example, a chromatographic column. The chromatographic device includes a column body formed of a metal or a metal alloy, e.g., titanium or stainless steel, or plastic, e.g., polyether ether ketone (PEEK). The inside surface of the column may or may not be coated to minimize non-specific interactions. The chromatographic device can be appropriately sized for use in high-performance liquid chromatography (HPLC) systems, ultra-high performance liquid chromatography (UHPLC) systems, or in fast protein liquid chromatography (FPLC) systems. These systems can further be connected to post-column detectors, such as ultraviolet (UV), tunable UV (TUV), photo diode array (PDA), refractive index (RI), multi-angle light scattering (MALS), mass spectrometry (MS), and/or fluorescence (FL) detectors.

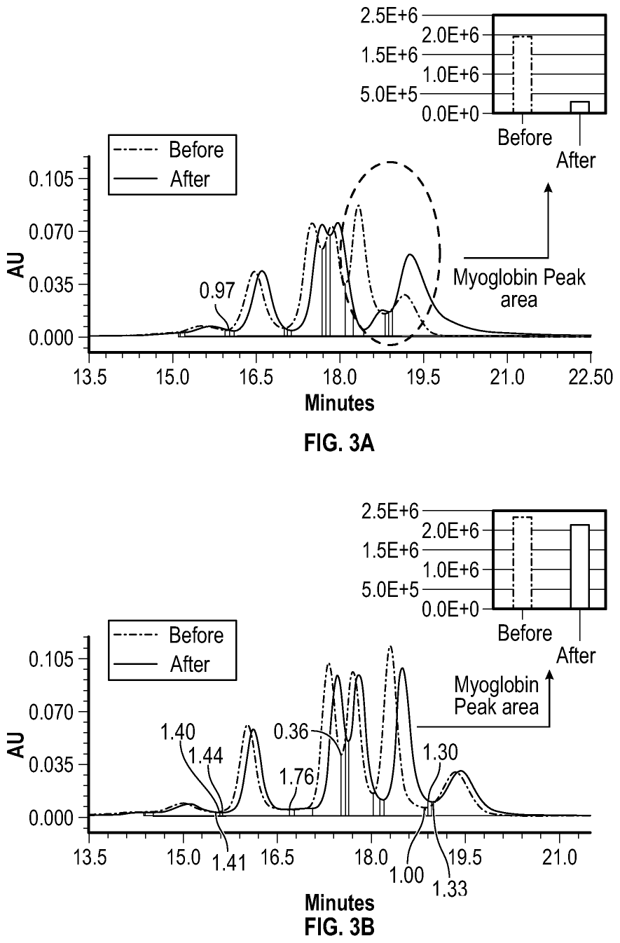

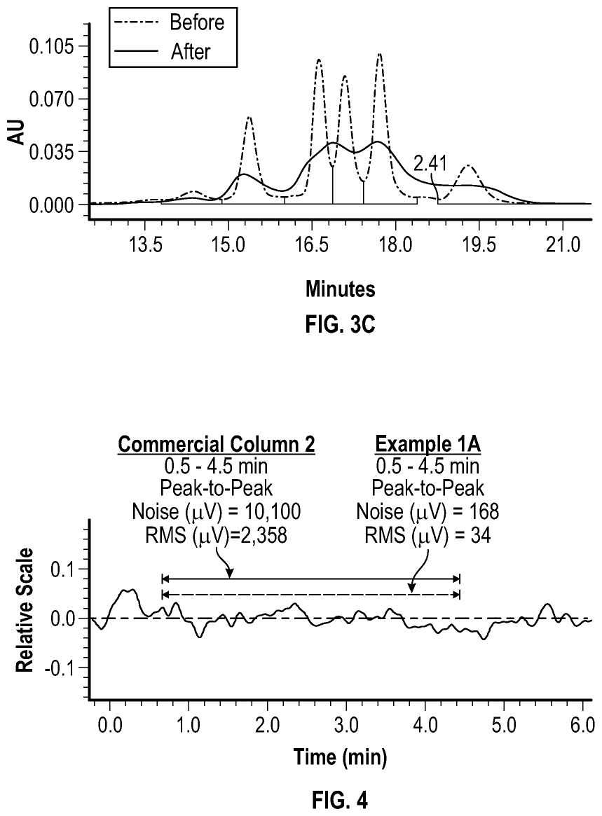

In one aspect, the materials disclosed herein have enhanced stability when exposed to basic conditions. This enhanced stability both increases its performance in chromatographic applications and allows for repeated use with minimum loss of efficacy. FIG. 3A-C demonstrates the enhanced base stability of the materials disclosed herein when used in size-exclusion chromatography. FIG. 3A shows the performance of materials that are not hybrid bonded, e.g., only contain functionalized silane without a dipodal hybrid silane. After exposure to prolonged basic conditions (pH 8.5 for 88 hours), the materials fail to provide adequate separation of myoglobin (comparing the black (after) and grey (before) traces in the circled region). Conversely, FIG. 3B shows that the hybrid-bonded materials of the present technology retain the ability to separate myoglobin following the same prolonged exposure to basic conditions. However, the degree of surface coverage of the functionalized silane, and consequentially the ratio of hybrid to functionalized region in the bonding phase is of import. FIG. 3C (corresponding to material from example 1D), which uses materials with a PEG surface coverage of 2.69 μmol/m² (˜200% of the theoretical maximum surface coverage and with a BTEE to PEG silane charged molar ratio of 1:1.24), does not withstand the prolonged basic conditions. Without wishing to be bound by any particular theory, this is believed to be due to the low molar ratio of OH-PEG to BTEE due to BTEE self-gelation in bonding, which results in fewer hybrid regions and thus reduced hydrophobic protection. Example 11 further details the base stability of the disclosed materials.

In one aspect, the materials disclosed herein have reduced baseline noise as compared to materials known in the art. This reduced baseline noise enhances the overall accuracy of analytical measurements made using chromatography applications. Large biomolecules are often assessed using SEC-MALS, which can determine the radii, molar mass, oligomeric state, and polydispersity of the separated molecules. However, commonly used silica materials shed silicates that range from 10 to 100 nm, which interfere with the light scattering of the molecules of interest. The materials of the instant disclosure result in substantially reduced MALS noise, thereby allowing more robust calculations of large biomolecules. In some embodiments of the instant technology, the MALS noise is reduced by ˜60× as compared to commercially available columns. FIG. 4 shows the highly variable MALS noise produced by a commercially available column as compared to columns packed with materials of the instant technology. Example 12 further details the reduced MALS noise of the disclosed materials.

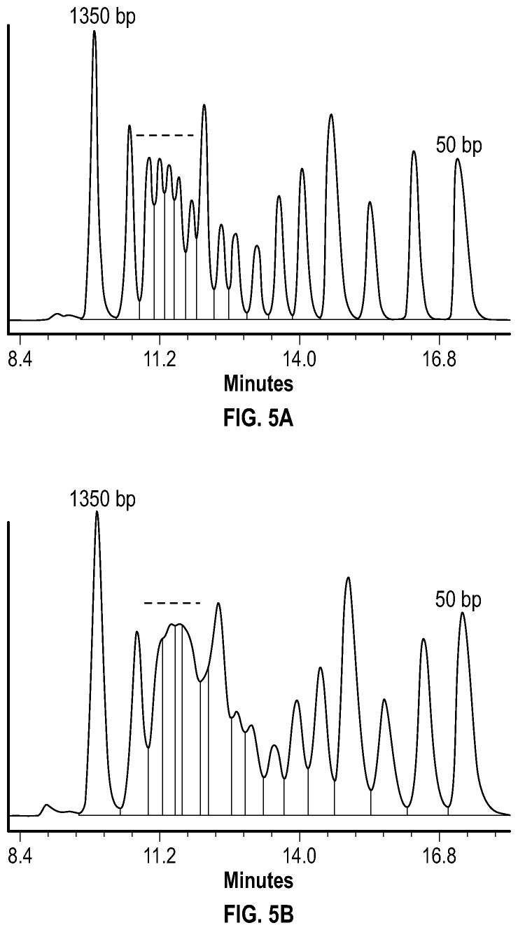

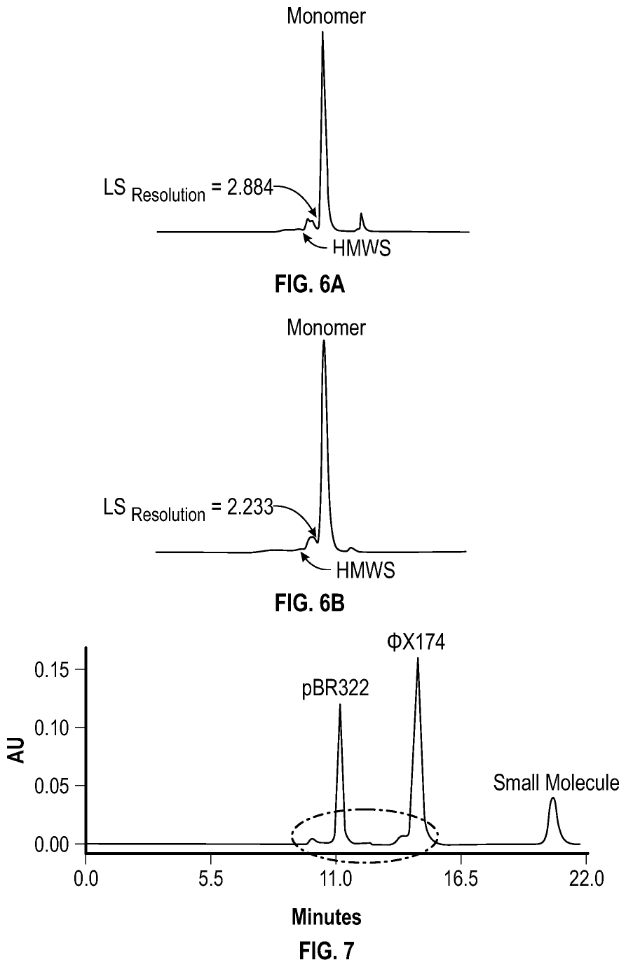

In another aspect, the materials disclosed herein afford superior resolution of DNA and AAV capsids as compared to materials known in the art. Materials of the instant technology were capable of resolving dsDNA across a range of 50-1500 bp (FIG. 5A, grey bar), whereas a commercially available column had poorer resolution and a higher baseline (FIG. 5B, grey bar). Similarly, materials of the instant technology afforded better resolution when separating an AAV capsid preparation (FIG. 6A) as compared to a commercially available column (FIG. 6B).

### EXAMPLES

### Example 1: Generation of a Hybrid PEG Bonding Phase on Wide Pore Silica Particles

A bonding phase consisting of a dipodal hybrid silane and an OH-PEG silane was generated on wide pore silica particles. A slurry containing 15 g of silica particle (average pore diameter of approximately 965 Å) in 174 mL of toluene was added to a 500 mL three neck round bottom flask equipped with a dean stark trap, condenser, thermometer, heating mantle, mechanical stirrer, and a nitrogen purge. The flask was heated to reflux at 110° C. for two hours. After two hours, 50 mL of condensed toluene was removed from the stark trap, and 25 mL was retained until the end of the bonding process. The reaction was then cooled to less than 40° C. and 360 μL of concentrated hydrogen chloride solution was added followed by 4.46 g of [hydroxy(polyethyleneoxy)₈₋₁₂propyl]triethoxysilane (OH-PEG) and 1.19 g of 1,2-bis(triethoxysilyl)ethane (BTEE). The reaction was heated to reflux (˜106° C.) for 20 h, after which the reaction was cooled to room temperature (RT). The particles were isolated via filtration then subsequently washed with toluene, ethanol, and water. Following the bonding reaction, further condensation of the remaining ethoxysilyl groups was performed using ammonium bicarbonate (100 mM) at 100° C. for 3 h. The reaction was cooled to RT and the particles isolated via filtration. The particles were subsequently washed with water to reduce the pH to less than 6, washed with acetone, and dried under vacuum at 70° C. for 16 h. The final particles contain ˜1.12% (by weight) of carbon and have an average pore diameter of ˜980 Å. The OH-PEG coverage is approximately 1.348 μmol/m².

By adjusting the concentration of BTEE used in the above process, the ratio of OH-PEG to BTEE can be altered. Table 1 shows parameters of resultant particles when different concentrations of BTEE were utilized.

TABLE 1
Hybrid-bonded Particles Resulting
from Different BTEE Concentrations

| | | | Hybrid-bonded Particle | | |
|---|---|---|---|---|---|
| | | | | OH-PEG | BTEE/OH-PEG |
| | Bonding Amount (g) | | C % | Coverage | Ratio |
| Example | OH-PEG | BTEE | (wt) | (μmol/m²) | (mol/mol) |
| 1A | 4.46 | 1.19 | 1.12 | 1.34 | 0.49 |
| 1B | 5.00 | 1.19 | 1.23 | 1.45 | 0.89 |
| 1C | 5.00 | 1.67 | 1.46 | 1.07 | 1.04 |
| 1D | 5.00 | 2.14 | 2.12 | 2.69 | 1.60 |

### Example 2: Delayed Addition of BTEE in the Formation of a Hybrid PEG Bonding Phase

The impact of delayed addition of BTEE in the formation of the hybrid PEG bonding phase was assessed. Particles were prepared as described in Example 1, with the exception that the addition of BTEE was delayed by 0, 1.5, 3, or 5 hours. As shown in Table 2, the delayed addition of BTEE resulted in a decrease in OH-PEG coverage.

TABLE 2
Hybrid-bonded Particles Resulting from Delayed BTEE Addition

| | | | | BTEE | Hybrid-bonded Particle | | |
|---|---|---|---|---|---|---|---|
| | Bonding Amount (g) | | | Addition | | OH-PEG | BTEE/OH- |
| | | OH- | | Delay | C % | Coverage | PEG Ratio |
| Example | Particle | PEG | BTEE | (h) | (wt) | (μmol/m²) | (mol/mol) |
| 2A | 15 | 5 | 1.19 | 0 | 1.14 | 1.55 | 0.49 |
| 2B | 15 | 5 | 1.19 | 3 | 1.12 | 1.50 | 0.68 |
| 2C | 15 | 5 | 1.19 | 5 | 0.97 | 1.32 | 0.89 |
| 2D | 15 | 5 | 0 | 0 | 1.12 | 1.54 | N/A |
| 2E | 40 | 13.3 | 3.4 | 3 | 1.18 | 1.58 | 0.96 |
| 2F | 40 | 13.3 | 3.4 | 1.5 | 1.24 | 1.69 | 0.96 |

### Example 3: Hybrid PEG Bonding on Ultrawide Pore Silica Particles

The impact of pore size in the formation of the hybrid PEG bonding phase was assessed. Particles with different pore sizes and particle sizes were bonded as described in Example 2B and as shown in Table 3. Pore size and particle size had a marginal impact on the final particle surface coverage, and the pore size did not decrease after hybrid bonding.

TABLE 3
Pore Size for Hybrid Bonded Particles

| | Base Particle | | | Hybrid Bonded Particle | | | |
|---|---|---|---|---|---|---|---|
| | Particle | Pore | Surface | Pore | | OH-PEG | BTEE/OH- |
| | Size, | size, | area, | size, | C % | Coverage | PEG ratio |
| Example | μm | Å | m²/g | Å | (wt) | (μmol/m²) | (mol/mol) |
| 3A | 3 | 1427 | 13.96 | N/A | 1.29 | 2.25 | 2.0 |
| 3B | 3 | 1641 | 20.79 | N/A | 0.91 | 1.60 | 0.9 |
| 3C | 3 | 1880 | 12.55 | N/A | 0.61 | 1.85 | 1.3 |
| 3D | 3 | 2150 | 16.75 | N/A | 0.62 | 1.35 | 0.8 |
| 3E | 10 | 2458 | 9.20 | 2561 | 0.38 | 1.08 | 0.3 |
| 3F | 5 | 2387 | 7.94 | 2515 | 0.24 | 0.79 | 0.2 |
| 3G | 5 | 3046 | 6.58 | 3248 | 0.27 | 1.07 | 0.2 |
| 3H | 5 | 4792 | 3.90 | 4895 | 0.21 | 1.41 | 2.3 |
| 3I | 10 | 4475 | 4.23 | 4733 | 0.18 | 1.11 | 0.5 |

### Example 4: Formation of a Hybrid PEG Bonding Phase on Hybrid-Coated Silica Particles

The ability to form a hybrid PEG bonding phase on hybrid-coated silica particles was determined. A hybrid-coated silica particle was prepared as follows. 26 g of porous silica particles (average pore diameter of 965 Å, pore volume of 0.83 cc/g measured by mercury porosimeter) dispersed in 480 mL of anhydrous toluene was added to a 1 L flask equipped with a dean stark trap, mechanical agitation, thermocouple, condenser, and a heating mantle. The reaction was heated to reflux at 110° C. for an hour and 25 mL of toluene was retained in the dean stark trap until the end of the coating process. After one hour of reflux, the reaction was cooled down to 40° C. 21.3 g of pre-condensed material based on a 4:1 molar ratio of TEOS and BTEE mixture (denoted as PEOS) was added to the reaction and stirred for 10 minutes. Then, 1.3 g of ammonium hydroxide (28-30% aqueous solution) was added to the reaction and stirred for another 10 minutes. The reaction was raised to 60° C. and held for two hours, after which the reaction was cooled to below 40° C. and the particles were isolated by filtration. The resultant particles were washed twice with ethanol and transferred to a 500 mL flask equipped with mechanical agitation, thermocouple, condenser, and heating mantle. 182 mL of purified lab water (i.e., purified using a Milli-Q® water purification system, available from MilliporeSigma), 78 mL of ethanol, and 26 g of ammonium hydroxide (28-30% aqueous solution) were added to the flask. The reaction was heated to 50° C. and held for two hours. The particles were then isolated by filtration and washed twice with 260 mL of methanol/water (1:1, v/v) followed by two washes with 260 mL of methanol. The coated particles were dried at 80° C. overnight under full vacuum. The resultant particles contained 0.5% carbon by weight.

A hybrid PEG bonding phase was then added to the particles using the process as described in Example 1. The resultant hybrid-bonded particles contained 1.26 μmol/m² of OH-PEG surface coverage, with a BTEE/OH-PEG ratio of 0.5 as shown in Table 4.

TABLE 4
Hybrid Bonding Phase on a Hybrid-Coated Silica Particle

| | | | Hybrid Bonding Phase | | |
|---|---|---|---|---|---|
| | | | | OH-PEG | BTEE/OH-PEG |
| | Bonding charge (g) | | C % | Coverage | ratio |
| Example | OH-PEG | BTEE | (wt) | (μmol/m²) | (mol/mol) |
| 4A | 5 | 1.19 | 1.40 | 1.26 | 0.52 |
| 4B | 5 | 0 | 1.35 | 1.16 | No BTEE |

### Example 5: Formation of Hybrid-Bonded Particles on Wide Pore Silica Particles

A slurry of 20 g of silica particles having an average pore diameter of about 1880 Å was re-dispersed in 211 mL of toluene and added to a 500 mL three neck round bottom flask equipped with a dean stark trap, condenser, thermometer, heating mantle, mechanical stirrer, and a nitrogen purge. The flask was heated to reflux at 110° C. for two hours. 50 mL of condensed toluene was removed from the stark trap and 25 mL was retained in the trap. After two hours of reflux, the reaction was cooled to less than 40° C. 600 μL of concentrated hydrogen chloride solution was added to the reaction, followed by 7.26 g of [hydroxy(polyethyleneoxy)₈₋₁₂propyl]triethoxysilane ethanol solution 50% (w/w) and 0.486 g of 1,2-bis(triethoxysilyl)ethane (BTEE) dissolved in 4.11 g of toluene. The reaction was then heated to reflux (˜106° C.) for 20 hours. After cooling to RT, the particles were isolated via filtration and washed with toluene, ethanol, and water. Further condensation of the remaining ethoxysilyl groups was performed using pH 10 ammonium bicarbonate (20 mM) at 100° C. for 3 hours. The reaction was cooled to RT and the particles were isolated via filtration. The particles were washed with water to reduce the pH below 6, washed with acetone, and dried under vacuum at 70° C. for 16 hours. The final particle (5A) contains 0.56% weight of carbon. Particles 5B, 5C, and 5D were achieved using the same method as described above but with different concentrations of BTEE as shown in Table 5.

TABLE 5
Characterization of Hybrid Bonding Phase

| | | | Hybrid bonding phase | | |
|---|---|---|---|---|---|
| | | | | OH-PEG | BTEE/OH-PEG |
| | Bonding charge, g | | C % | coverage | ratio |
| Example | OH-PEG | BTEE | (wt) | (umol/m²) | (mol/mol) |
| 5A | 7.26 | 0.485 | 0.56 | 1.69 | 1.0 |
| 5B | 7.26 | 0.395 | 0.52 | 1.65 | 0.5 |
| 5C | 7.26 | 0.243 | 0.61 | 1.85 | 0.35 |
| 5D | 7.26 | 0.144 | 0.43 | 1.72 | 0.1 |

### Example 6: Generation of a Hybrid PEG Bonding Phase on Porous Hybrid Particles

The hybrid PEG bonding phase is added to hybrid particles with a pore size of ˜450 Å and a C % of 6.67 by weight using the process as described in Example 1.

### Example 7: Generation of a Hybrid Diol Bonding Phase on Porous Hybrid Particles

A slurry containing 15 g of hybrid particles (pore size of ˜450 Å and a C % of 6.67) is re-dispersed in ethyl acetate buffer (pH 5.7) and added to a 500 mL three neck round bottom flask equipped with condenser, thermometer, heating mantle, mechanical stirring, and nitrogen purge. The flask is heated to 70° C., after which 5 g of (3-glycidyloxypropyl)triethoxylsilane and 1 g of BTEE is added. The reaction is maintained at 70° C. for 20 h and then cooled to RT. The particles are isolated via filtration and washed until a neutral pH. The particles are transferred to a 250 mL round bottom flask, and 150 mL of 0.5M acetic acid is added. The flask is heated to 60° C. and maintained for 20 h. The reaction is cooled to RT and the particles are isolated via filtration. The particles are washed with water, methanol, and then dried under vacuum at 70° C. for 16 h.

### Example 8: Generation of a Hybrid Biphenyl Bonding Phase on a Superficially Hybrid Particle

A slurry containing 15 g of hybrid particle (pore size of ˜130 Å and a C % of 6.67) re-dispersed in 174 mL of toluene is utilized. The hybrid biphenyl bonding phase is added to the particles using the process as described in Example 1, with the exception that 4-biphenyltriethoxysilane is utilized instead of [hydroxy(polyethyleneoxy)₈₋₁₂propyl]triethoxysilane.

### Example 9: Generation of a Hybrid C18 Bonding Phase on a Hybrid-Coated Non-Porous Polymer Particle

A slurry containing 15 g of hybrid-coated (TEOS/BTEE molar ratio of 1/1.5) non-porous polymer particle (C % of 54, 2.2 μm diameter) re-dispersed in 174 mL of toluene is utilized. The hybrid C18 bonding phase is added to the particles using the process as described in Example 1, with the exception that n-octadecyltricholorosilane is utilized instead of [hydroxy(polyethyleneoxy)₈₋₁₂propyl]triethoxysilane.

### Example 10: Generation of a Hybrid C8 Bonding Phase on a Porous Hybrid-Coated Particle

A slurry containing 15 g of hybrid particle (pore size of ˜130 Å and a C % of 6.67) re-dispersed in 174 mL of toluene is utilized. The hybrid C8 bonding phase is added using the process as described in Example 1, with the exception that n-octyltrichlorosilane is utilized instead of [hydroxy(polyethyleneoxy)₈₋₁₂propyl]triethoxysilane.

### Example 11: Generation of a Hybrid C4 Bonding Phase on a Porous Silica Particle

A slurry containing 15 g of silica particle (pore size of ˜90 Å) re-dispersed in 174 mL of toluene is utilized. The hybrid C4 bonding phase is added using the process as described in Example 1, with the exception that n-butyltrichlorosilane is utilized instead of [hydroxy(polyethyleneoxy)₈₋₁₂propyl]triethoxysilane.

### Example 12: Base stability of Hybrid-bonded Particles

The base stability of the hybrid-bonded particles was assessed. Two 4.6×150 mm columns were packed with material 1A and 1D from Example 1, respectively. The third column, as a control, was packed with material 2D, from Example 2, made only by using OH-PEG (i.e., not hybrid-bonded).

Each column was connected to a Waters Acquity™ H-class UPLC™ chromatographic system (available from Waters Technologies Corporation, Milford, MA) and heated in a column chamber to 40° C. An isocratic separation of a protein/nucleoside mixture containing thyroglobulin (3 mg/mL), IgG (2 mg/mL), BSA (5 mg/mL), myoglobin (2 mg/mL), and uracil (0.1 mg/mL) was initially performed. The mobile phase was 0.02M PBS, with a flow rate of 0.2 mL/min. Effluent was monitored using a UV detector (280 nm).

Following the initial separation, 100 mM ammonium acetate buffer (pH 8.5) was flowed across each column at a constant flow rate of 0.2 mL/min for 88 hours. After this wash period, a second isocratic separation was performed. The results are shown in FIG. 3A-C. FIG. 3A shows the control column containing material with only OH-PEG. As shown in the circled portion of the chromatograph, the capacity for the column to separate myoglobin was substantially diminished following the 88 h wash in 100 mM ammonium acetate buffer (pH 8.5), comparing the grey trace (before wash) to the black trace (after wash). In contrast, FIG. 3B shows that the hybrid-bonded material 1A exhibited substantially equivalent separation before and after the wash in 100 mM ammonium acetate buffer (pH 8.5). Notably, as shown in FIG. 3C, the hybrid-bonded material 1D failed to provide any separation following the 100 mM ammonium acetate buffer wash.

### Example 13: SEC-MALS Noise of Hybrid-Bonded Particles

The SEC-MALS noise of the hybrid-bonded particles was assessed. A 4.6×150 mm column was packed with material 1A from Example 1. As a control, a 4.6×150 mm column was packed with material 2D, from Example 2, made only by using OH-PEG (i.e., not hybrid-bonded).

Each column was flushed with 20 column volumes (CV) of 2×PBS prior to connection to the MALS detector. Baseline voltage was observed over 0.5 to 4.5 minutes (corresponding to 54 to 177 mL of flow) and the peak-to-peak noise and RMS noise were calculated. RMS was calculated by dividing the peak-to-peak noise by 6.6). The column packed with material 1A exhibited low peak-to-peak noise after 177 mL of flow, at numbers that exceed the requirements for performing a detailed and sensitive analysis of low abundance large macromolecules. In contrast, the column packed with control material 2D exhibited almost double the peak-to-peak noise and RMS. A commercially available SEC column (Sepax 1000LS available from Sepax Technologies, Inc., Newark, Delaware) exhibited ˜60× more peak-to-peak noise than material 1A. FIG. 4 shows the MALS noise generated by the commercial column (black line) relative to the column packed with material 1A (dashed line). A summary of the MALS noise observed for columns packed with various materials of the present technology is provided in Table 6.

TABLE 6
MALS Noise of Hybrid-Bonded Particles

| Packing Material | Peak-to-Peak Noise (μV) | RMS (μV) |
|---|---|---|
| Example 2D | 377 | 60 |
| Sepax 1000LS | 10,100 | 2,358 |
| Example 1A | 168 | 34 |
| Example 1B | 171 | 33 |
| Example 2A | 162 | 30 |
| Example 2B | 183 | 33 |

### Example 14: Separation of DNA Fragments Using Hybrid-Bonded Particles

The components of a DNA ladder (0.5 mg/mL, New England Biolabs, ranging from 1350 bp to 50 bp) were separated on columns packed with either hybrid-bonded particles of Example 2 Å (FIG. 5A) or a commercial column comprising OH-PEG bonding only (i.e., not hybrid-bonded) (FIG. 5B). The columns were connected to a Waters Acquity™ H-class UPLC™ chromatographic system (available from Waters Technologies Corporation, Milford, MA), and a 5 uL injection of sample was flowed on the column using a mobile phase of 0.02M phosphate buffered saline and a column temperature of 30 C. As shown in FIG. 5A, the materials of the instant technology afford separation of dsDNA ranging from 766-550 bp, whereas the commercial column is unable to resolve these species and has a generally higher baseline (FIG. 5B).

### Example 15: Separation of AAV Capsids Using Hybrid-Bonded Particles

An AAV2 capsid serotype preparation (15 uL, 1×1013 vg/mL, Virovek) was separated on columns packed with either hybrid-bonded particles of Example 2 Å (FIG. 6A) or a commercial column comprising OH-PEG bonding only (i.e., not hybrid-bonded) (FIG. 6B). The columns were connected to a Waters Acquity™ H-class UPLC™ chromatographic system (available from Waters Technologies Corporation, Milford, MA), and a 30 uL injection of sample was flowed on the column using a mobile phase of 0.02M phosphate buffered saline and a column temperature of 30 C. As shown in FIG. 6A, the materials of the instant technology afford higher resolution of the monomer and higher molecular weight species as compared to the commercial column (FIG. 6B).

### Example 16: Separation of Plasmid DNA Using Hybrid-Bonded Particles

A mixture of plasmid and virion DNA was separated using size-exclusion chromatography on columns packed with hybrid-bonded particles of Example 3B. Equal amounts (1 mg/mL) of plasmid dsDNA (pBR322) and virion ssDNA (ΦDX174) were mixed and 1 μL of the mixture was injected on a 4.6×150 mm column packed with the hybrid-bonded particles of Example 3B, having an average pore size of 2000 Å. The column was connected to a Waters Acquity™ H-Class UPLC™ chromatographic system (available from Waters Technologies Corporation, Milford, MA) and the sample separated using 1× phosphate buffered saline (1×PBS; 10.14 mM sodium phosphate pH 7.4, 137 mM sodium chloride, 2.7 mM potassium chloride) at 35° C. with a 0.1 mL/min flow rate. Eluent was monitored using a UV detector at 260 nm. As shown in FIG. 7, the hybrid-bonded particles of Example 3B afforded separation of the double-stranded plasmid DNA and the single-stranded virion DNA.

### Example 17: Separation of Lipid Nanoparticles Using Hybrid-Bonded Particles

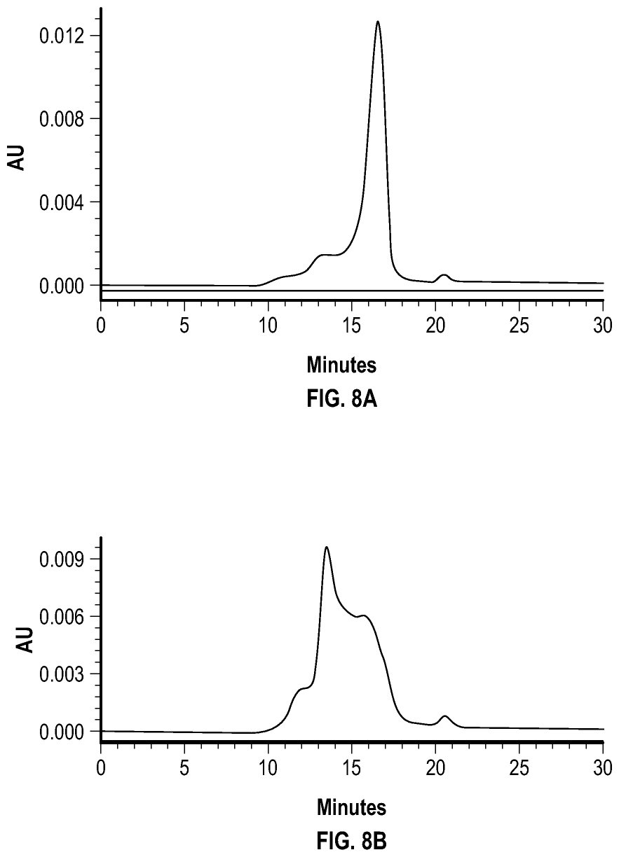

Samples comprising lipid nanoparticles (LNPs) were separated using size-exclusion chromatography on columns packed with hybrid-bonded particles of Example 3B. 2 μL of LNP Sample #1 or 4 μL of LNP Sample #2 were injected on a 4.6×150 mm column packed with the hybrid-bonded particles of Example 3B, having an average pore size of 2000 Å. The column was connected to a Waters Acquity™ H-Class UPLC™ chromatographic system (available from Waters Technologies Corporation, Milford, MA) and the sample separated using 0.1×PBS (1.014 mM sodium phosphate pH 7.4, 13.7 mM sodium chloride, and 0.27 mM potassium chloride) at 35° C. with a 0.1 mL/min flow rate. Eluent was monitored using a UV detector at 260 nm. As shown in FIG. 8A (LNP Sample #1) and FIG. 8B (LNP Sample #2), the hybrid-bonded particles of Example 3B result in a separation that demonstrates the heterogeneity of lipid nanoparticles present in the LNP samples.

1. A chromatographic material comprising:
a particle with a siliceous surface, wherein the siliceous surface consists of a bonding phase formed by at least two silane compounds, wherein:
one of the at least two silane compounds is a dipodal hybrid silane comprising two indirectly linked silica atoms, and
one of the at least two silane compounds is a functionalized silane.

2. The chromatographic material of claim 1, wherein the particle is a polymer particle, a silica particle, or an inorganic-organic hybrid particle.

3. The chromatographic material of claim 1, wherein the dipodal hybrid silane is selected from the group consisting of: 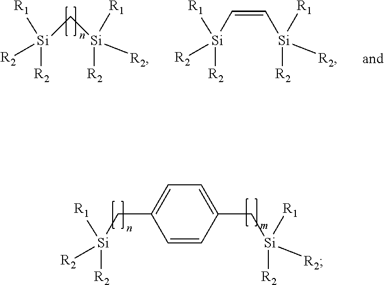
wherein
R₁ is each independently chlorine, methoxyl, or ethoxyl;
R₂ is each independently alkyl, methoxyl, ethoxyl, or chlorine; and
n and m are each independently 1-4.

4. The chromatographic material of claim 1-3, wherein the functionalized silane is selected from the group consisting of: 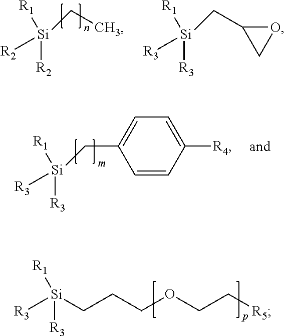
wherein
R₁ is each independently chlorine, methoxyl, or ethoxyl;
R₂ is each independently alkyl, benzyl, methoxyl, ethoxyl, or chlorine;
R₃ is each independently alkyl, methoxyl, ethoxyl, or chlorine;
R₄ is H or benzene;
R₅ is hydroxyl or methoxyl;
n is 3, 7, or 17;
m is 0 or 1; and
p is an integer from 1-12.

5. The chromatographic material of claim 1, wherein the dipodal hybrid silane and the functionalized silane are charged at a molar ratio of about 1:1, about 1:2, about 1:4 or about 1:10.

6. The chromatographic material of claim 5, wherein the dipodal hybrid silane and the functional silane are charged at a molar ratio of about 1:2 or about 1:4.

7. The chromatographic material of claim 1, wherein the dipodal hybrid silane and the functional silane are present at a value between a molar ratio from 0.1:1 to 3:1.

8. The chromatographic material of claim 1, wherein the functionalized silane has a surface coverage of 60% to 250% of a theoretical maximum surface coverage (μmol/m²) of the functionalized silane.

9. The chromatographic material of claim 1, wherein the functionalized silane is 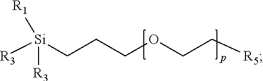
wherein
R₁ and R₃ are ethoxyl;
R₅ is hydroxyl; and
p is 8-12.

10. The chromatographic material of claim 9, wherein the surface coverage of the functionalized silane is between about 0.8 to about 3.45 μmol/m².

11. The chromatographic material of claim 1, wherein the particle has an average pore size of between about 90 Å to about 5000 Å.

12. (canceled)

13. The chromatographic material of claim 1, wherein the chromatographic material is resistant to hydrolytic corrosion as detected by minimum change of separation performance before and after exposure to the hydrolytic condition.

14. The chromatographic material of claim 1, wherein the chromatographic material shows low baseline noise as measured by a multi-angle light scattering (MALS) detector.

15. A chromatographic column comprising the chromatographic material of claim 1.

16. A chromatographic device comprising:
the chromatographic column of claim 15,
a column injector positioned upstream of the chromatographic column, and tubing in fluidic connection with and located downstream of the chromatographic column.

17. The chromatographic device of claim 16, further comprising a detector in fluidic connection with and located downstream of the chromatographic column.

18. The chromatographic device of claim 17, wherein the detector is a multi-angle light scattering (MALS) detector and/or an ultraviolet detector.

19. The chromatographic device of claim 16 for use in size exclusion chromatography or reversed-phase chromatography.

20. The chromatographic device of claim 16, wherein the chromatographic material is resistant to hydrolytic corrosion as detected by MALS noise and/or by separation of a protein and/or nucleoside sample.

21. The chromatographic device of claim 20, wherein the MALS noise is measured as peak-to-peak noise in μV, and wherein the peak-to-peak noise is ≤800 μV.
